(19) United States
(12) Patent Application Publication
(10) Pub. No.: US 2021/0101113 A1
(43) Pub. Date: Apr. 8, 2021

(54) PURIFICATION OF POLLUTED AIR USING MICRO-ORGANISM-CONTAINING PARTICULATE MEDIA

(71) Applicant: Erasmus VAN NIEKERK, Bern (CH)

(72) Inventor: Erasmus VAN NIEKERK, Bern (CH)

(21) Appl. No.: 16/071,637

(22) PCT Filed: Jan. 19, 2017
(86) PCT No.: PCT/IB2017/050278

§ 371 Date: Jul. 20, 2018

(30) Foreign Application Priority Data
Jan. 20, 2016 (ZA) 2016/00429

(51) Int. Cl. B01D 53/75; B01D 53/85; B01D 53/14; B01D 53/18; B01D 53/04; B01D 53/73

(52) U.S. Cl. CPC B01D 53/75; B01D 53/85; B01D 53/1468; B01D 53/1412; B01D 53/1425; B01D 53/18; B01D 2252/103; B01D 53/0407; B01D 53/73; B01D 2253/102; B01D 2253/108; B01D 2257/304; B01D 2257/702; B01D 53/1418

(57) ABSTRACT

A process for purifying polluted air, includes passing polluted air through a fluidized bed of micro-organism-containing primary particulate media so that, as the polluted air passes through the fluidized bed, organic pollutants therein are removed by the micro-organisms. Partially purified air containing a lower level of the organic pollutants than the polluted air that enters the fluidized bed, emerges from the fluidized bed. The partially purified air is passed through a static bed of secondary particulate media thereby to remove residual organic pollutants from the partially purified air. Purified air is thus produced.

THIS INVENTION relates to the purification of polluted air. It relates, in particular, to a process for purifying polluted air, to air purification apparatus, to an air scrubber, and to an air purification installation.

Accordingly to a first aspect of the invention, there is provided a process for purifying polluted air, which process includes
passing polluted air through a fluidized bed of micro-organism-containing primary particulate media so that, as the polluted air passes through the fluidized bed, organic pollutants therein are removed by the micro-organisms, with partially purified air containing a lower level of the organic pollutants than the polluted air that enters the fluidized bed, emerging from the fluidized bed; and
passing the partially purified air through a static bed of secondary particulate media thereby to remove residual organic pollutants from the partially purified air, with purified air being produced.

The static bed may be located above the fluidized bed so that the partially purified air passes upwardly from the fluidized bed through the static bed, with the purified air being withdrawn from the top of the static bed.

The secondary particulate media may be particles of activated carbon, zeolite, or the like.

Purification of the partially purified air in the static bed may involve removal from and/or polishing of residual complex aromatic components in the partially purified air. The secondary particulate media may thus have surface coatings of microorganisms suitable for effecting said removal and/or polishing.

In one embodiment of the invention, the fluidized and static beds may have the same, or about the same, pH. However, in another embodiment, their pHs may be different so that a different microbic family will be treated in the static bed component to that treated in the fluidized bed.

The process may include controlling the humidity of the fluidized bed. This may be effected by spraying water onto the fluidized bed, or into a zone above the fluidized bed. Water vapour/droplets are carried over from said zone into the static bed, thereby to humidify the static bed.

The process may include simultaneously stirring the fluidized bed as the polluted air passes through it, to enhance removal and/or decomposition of the microorganisms.

The polluted air passing through the fluidized bed may also act as fluidizing medium for its particulate media. The air flow rate may be from 0.7 m/s to 1.5 m/s.

The process may include
allowing solid matter that accumulates on the particulate media as pollutants are removed from the polluted air as it passes through the fluidized bed, to segregate therefrom and to pass into a collection zone below the fluidized bed; and
removing the solid matter from the collection zone.

The collection zone may include a floor on which the solid matter accumulates, and an opening through which the solid matter is removed. The removal of the solid matter may be by means of suction, and the suction may be created by a cyclone operatively connected to the opening. The collection zone may be circular in cross section, with a radially extending channel being provided in the floor of the collection zone, and with the outer end of the channel providing said opening and being connected to the cyclone.

The process may include urging solid matter that accumulates on the floor into the channel by means of a rotating sweeper which sweeps solid matter on the floor into the channel as it rotates, such that, as the sweeper rotates, the sweeper momentarily seals off the channel thus creating a vacuum in the channel filled with solid matter which is extracted over the entire radius of the floor into the cyclone.

The process which may also include initially, before passing the polluted air through the fluidized bed,
passing it through a scrubbing zone in which the air is scrubbed with brine, thereby removing pollutants, including hydrogen sulphide, from the air, and with the pollutants being entrained by and/or adsorbed by and/or dissolved in the brine;
controlling the pH of the brine to enhance hydrogen sulphide adsorption;
cleaning the brine to remove entrained, adsorbed and/or dissolved pollutants therefrom;
treating the brine to convert hydrogen sulphide therein to a salt; and
recycling the treated brined to the scrubbing zone.

The process may instead further include initially, before passing the polluted air through the fluidized bed,
passing it through a scrubbing zone in which the air is scrubbed with brine, thereby to pretreat the polluted air, and with pollutants, including hydrogen sulphide, being entrained by and/or adsorbed by and/or dissolved in the brine; and
   thereafter, passing the pretreated polluted air through a bed of micro-organism-containing particulate media so that, as the polluted air passes through the bed, organic pollutants therein are removed by the micro-organisms, with purified air containing a lower level of the organic pollutants than the polluted air that enters the bed, emerging from the bed.

According to a second aspect of the invention, there is provided air purification apparatus, which includes
a vessel providing an air purification chamber, with the vessel being adapted such that polluted air can enter the air purification chamber at a low level;
a plurality of micro-organism-containing primary particulate media in the air purification chamber, the primary particulate media being capable of being fluidized by air which passes through the air purification chamber; and
a bed of secondary particulate media located above the primary particulate media so that, in use, partially purified air emerging from the fluidized bed passes through the bed of secondary particulate media, for further purification thereof.

The secondary particulate media may be as hereinbefore described.

The apparatus may include water injection means, e.g. at least one water spray nozzle between the beds, with the water injection means adapted to spray water onto the micro-organism-containing primary particulate media, or into a zone above said media and below the bed of secondary particulate media.

The apparatus may include a mixer in the air purification chamber for mixing a fluidized bed of the primary particulate media which forms in the air purification chamber, in use.

The apparatus may include
an air purification zone within the chamber and adapted to contain a bed of primary particulate media comprising micro-organism-containing particulate media;
a solids collection zone below the air purification zone, with a solids removal opening in the vessel for removing solids from the solids collection zone.

The vessel may include, in the air purification zone, a foraminous support supporting the bed and which permits solids to pass from the bed into the collection zone.

The vessel may also include a floor for the collection zone. The floor of the vessel may be of circular cylindrical form so that the collection zone is circular in cross-section, wherein a radially extending channel is provided in the floor of the collection zone, and wherein a rotating sweeper, which sweeps solid matter on the floor into the channel as it rotates, is provided such that, in use, the sweeper momentarily seals off the channel thus creating a vacuum in the channel filled with solid matter.

According to a third aspect of the invention, there is provided a process for purifying polluted air, which process includes.
passing polluted air through a bed of micro-organism-containing particulate media so that, as the polluted air passes through the bed, organic pollutants therein are removed by the micro-organisms, with purified air containing a lower level of the organic pollutants than the polluted air that enters the bed, emerging from the bed;
allowing solid matter that accumulates on the particulate media as pollutants are removed from the polluted air as it passes through the bed, to segregate therefrom and to pass into a collection zone below the bed; and
removing the solid matter from the collection zone.

The bed of particulate media may, in particular, be a fluidized bed.

The collection zone may include a floor on which the solid matter accumulates, and an opening through which the solid matter is removed. The removal of the solid matter may be by means of suction. The suction may be that created by a cyclone operatively connected to the opening. The suction in the cyclone may in turn be generated by drawing air from the cyclone into the suction of the fan; the fan may be the same as that used to force air through the fluidized bed and which fluidizes the bed.

The collection zone may be circular in cross section, with a radially extending channel being provided in the floor of the collection zone, and with the outer end of the channel providing said opening and being connected to the cyclone.

The process may include urging solid matter that accumulates on the floor, into the channel. This may be effected by means of a rotating sweeper which sweeps solid matter on the floor into the channel as it rotates. As it rotates, the sweeper momentarily seals off the channel thus creating a vacuum in the channel filled with solid matter which may thus be extracted over the entire radius of the floor into the cyclone.

According to a fourth aspect of the invention, there is provided air purification apparatus, which includes
a vessel providing an air purification chamber, with the vessel being adapted such that polluted air can enter the air pollution chamber at a low level;
an air purification zone within the chamber and adapted to contain a bed of micro-organism-containing particulate media;
a solids collection zone below the air purification zone, with a solids removal opening in the vessel for removing solids from the solids collection zone.

The apparatus may include the bed of micro-organism-containing particulate media in the air purification zone.

The vessel may include, in the air purification zone, a foraminous support supporting the bed and which permits solids to pass from the bed into the collection zone.

The vessel may include a floor for the collection zone. The vessel may be of circular cylindrical form so that the collection zone is circular in cross-section.

A channel in the vessel floor and a sweeper as hereinbefore described, may also be provided.

The bed of micro-organism-containing particulate media (hereinafter also referred to as “primary media”) may be adapted to be fluidized, in use.

The vessel may then also include a bed of secondary particulate media located above the primary particulate media. In use, (partially) purified air emerging from the fluidized bed passes through the bed of secondary particulate media, for further purification of the air.

According to a fifth aspect of the invention, there is provided a process for purifying polluted air, which process includes
passing polluted air through a scrubbing zone in which the air is scrubbed with brine, thereby removing pollutants, including hydrogen sulphide, from the air, and with the pollutants being entrained by and/or adsorbed by and/or dissolved in the brine;
controlling the pH of the brine to enhance hydrogen sulphide adsorption;
cleaning the brine to remove entrained, adsorbed and/or dissolved pollutants therefrom;
treating the brine to convert hydrogen sulphide therein to a salt; and
recycling the treated brine to the scrubbing zone.

Controlling of the brine pH may include monitoring the pH of the brine and, if necessary, adjusting its pH, e.g. by adding an alkaline substance, particularly an alkali metal hydroxide such as sodium hydroxide, to the brine. The pH control of the brine may, instead of additionally, include adding an acid to the brine, to enhance ammonia (NH₃) removal from the air.

Thus, sodium hydroxide will be introduced, e.g. injected, into the brine to raise and maintain its pH at an optimal level for hydrogen sulphide (H₂S) adsorption from the air. To achieve this, the brine should be as clean as possible, hence the cleaning of the brine in order to maintain its pH with minimal sodium hydroxide addition.

Cleaning of the brine may include filtering it to remove pollutants, e.g. solid impurities therefrom.

The process may include controlling and optimizing, e.g. by means of a programmable logic controller (‘PLC’) or the like, the sodium hydroxide addition into the brine. This may be effected by measuring the H₂S value in the air at an inlet to the scrubbing zone and comparing it with the brine pH; any reduction in brine pH (e.g. as a result of increased H₂S levels in the air) will then result in sodium hydroxide dosage being increased, to maintain the brine pH at said optimum level.

The process may include cleaning or replacing a filter through which the brine passes (to effect the filtering thereof), when the total dissolved solids (TDS) and/or conductivity of the filtered brine reaches a predetermined high or maximum value.

The filtering of the brine may be effected in a sand filter. The process may include from time-to-time backwashing the sand filter, to clean or regenerate it.

The hydrogen sulphide (H₂S) treatment may be effected by injecting ozone into the brine. The process may include delaying cleaning, e.g. backwashing, of the filter when dictated by high TDS and/or conductivity levels in the filtered brine, if any H₂S is detected, e.g. by a controller such as a PLC, in the filtered brine; instead, ozone injection into the brine may then be increased for a period of time to reduce the H₂S content of the brine to zero before filter cleaning takes place, i.e. when the brine is H₂S free.

According to a sixth aspect of the invention, there is provided an air scrubber, which includes
a vessel defining a scrubbing zone and having and an air inlet an air outlet;
brine introduction means for introducing scrubbing brine into the scrubbing zone;
air contact media within the scrubbing zone;
brine recycling means for recycling brine to the brine introduction means;
pH control means for controlling the pH of the brine;
brine cleaning means for cleaning the brine; and
hydrogen sulphide treatment means for treating hydrogen sulphide present in brine.

The brine cleaning means may include a filter, for filtering spent brine, connected to the vessel, e.g. to a brine sump of the vessel. The filter may be a sand filter; backwashing means, for backwashing the sand filter, may be provided.

The filter may be connected to the vessel by means of a brine conduit. The hydrogen sulphide (H₂S) treatment means may comprise oxidation means for oxidizing the H₂S, e.g. an ozone generator and an ozone conduit leading into the brine conduit. The ozone may be injected or introduced into the brine conduit by means of a venturi mounted in the brine conduit and connected to the ozone conduit.

The brine recycling means may include a brine recycling pump for recycling filtered brine to the brine introduction means.

The pH control means may include injection means for injecting an alkaline substance, such as NaOH, into the brine and a pH measuring device for measuring the brine pH. The control means may also include an electronic controller, particularly a PLC, operatively connected to an H₂S probe at or near the vessel air inlet, and to the pH measuring device. Thus, by means of the PLC NaOH addition to the brine will, in use, be controlled in response to the H₂S concentration in air entering the air inlet, as hereinbefore described.

The scrubber may include control means (which may be the PLC hereinbefore described) for controlling backwashing of the sand filter in response to TDS concentration and/or conductivity of filtered brine; the controller may also monitor H₂S levels in the brine, with ozone production being increased, in use, to reduce H₂S levels in the brine to an acceptable value, such as zero, before any backwashing is effected.

According to a seventh aspect of the invention, there is provided a process for purifying polluted air, which process includes
passing polluted air through a scrubbing zone in which the air is scrubbed with brine, thereby to pretreat the polluted air, and with pollutants, including hydrogen sulphide, being entrained by and/or adsorbed by and/or dissolved in the brine; and
thereafter, passing the pretreated polluted air through a bed of micro-organism-containing particulate media so that, as the polluted air passes through the bed, organic pollutants therein are removed by the micro-organisms, with purified air containing a lower level of the organic pollutants than the polluted air that enters the bed, emerging from the bed.

The process may include continually introducing, e.g. spraying, brine into the scrubbing zone while the air passes through it, optionally while passing the polluted air over packing, such as at least one bed of pall rings. The water will serve to extract water soluble compounds, e.g. salts, from the polluted air, with these salts hence accumulating in the water, i.e. brine is formed. Pollutants such as H₂S will be adsorbed into the brine, while solid pollutants will be entrained by the water.

The process may include
controlling the brine pH to enhance hydrogen sulphide adsorption as hereinbefore described; and/or
cleaning the brine to remove entrained, adsorbed and/or dissolved pollutants therefrom as hereinbefore described; and/or
treating the brine to convert H₂S therein to a salt as hereinbefore described; and/or
recycling the brine to the scrubbing zone as hereinbefore described.

The process may include filtering the brine, either continuously or from time-to-time, as hereinbefore described, to remove therefrom solid matter that is removed from the polluted air by the water.

The process may also include measuring and/or monitoring one or more of the following variables: inlet and/or outlet H₂S concentration in the air and/or brine, brine water conductivity and total dissolved solids (TDS) level in the brine.

The bed of micro-organism-containing particulate media may be a fluidized bed as hereinbefore described; the process may then include passing partially purified air emerging from the fluidized bed through a static bed as also hereinbefore described.

The process may also include allowing solid matter that accumulates on the particulate media of the bed of micro-organism-containing particulate media to segregate therefrom and to pass into a collection zone below the bed, and removing the solid matter from the collection zone, as hereinbefore described.

The process may further include treating the brine, as hereinbefore described.

According to an eighth aspect of the invention, there is provided an air purification installation, which includes
an air scrubber having an air inlet and an air outlet spaced from the inlet;
a vessel providing an air purification chamber, with an air purification zone, adapted to contain a bed of micro-organism-containing media, being provided within the chamber; and
air displacement means between the scrubber and the vessel, with the scrubber air outlet being connected to an air inlet of the air displacement means, and an air outlet of the air displacement means being connected to the vessel.

The air displacement means may be a fan. The vessel may be that of air purification means as hereinbefore described. The installation may thus include air purification means as hereinbefore described.

The air scrubber may be as hereinbefore described. The air purification apparatus thus comprises, or is in the form of, a biological reactor.

The invention will now be described in more detail with reference to the accompanying diagrammatic drawings.

In the drawings,

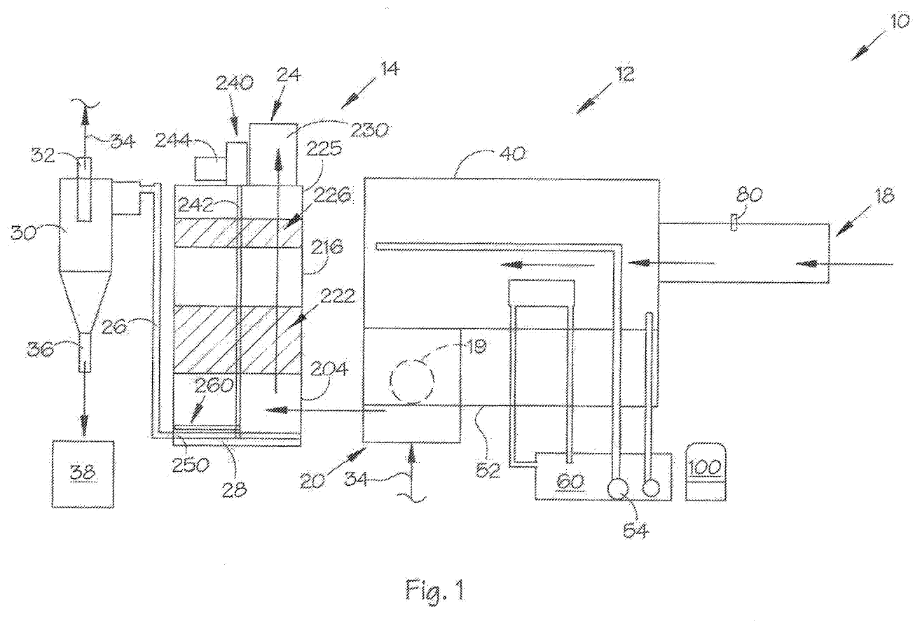

FIG. 1 shows, schematically, a side view of an air purification installation according to the invention;

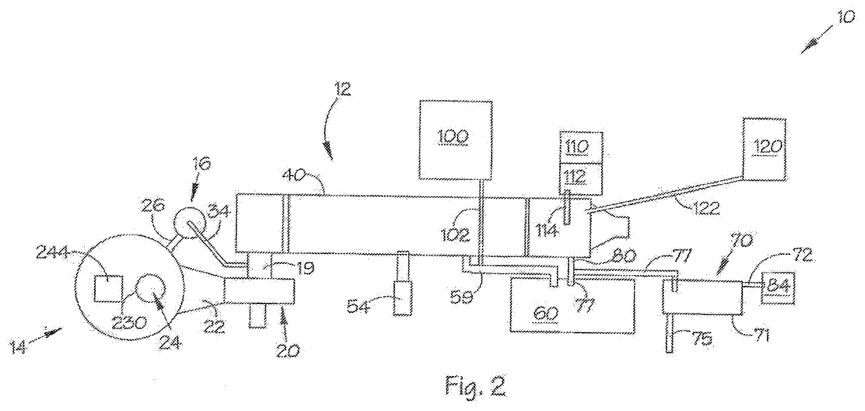

FIG. 2 shows, schematically, a plan view of the air purification apparatus of FIG. 1;

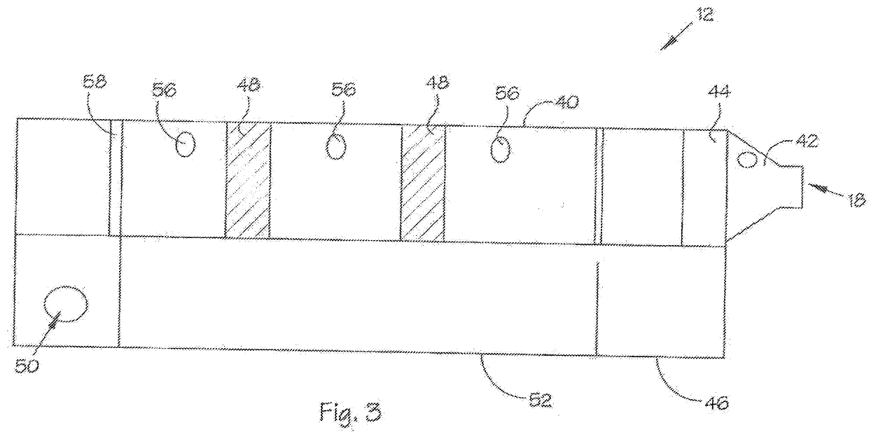

FIG. 3 shows, schematically, an enlarged side view of the scrubber shown in FIG. 1;

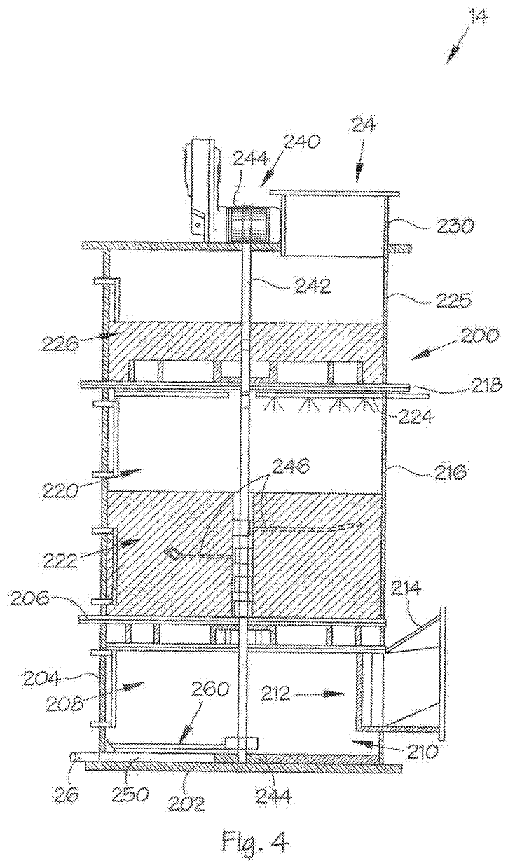

FIG. 4 shows, schematically, a longitudinal sectional view of the biological reactor of FIG. 1;

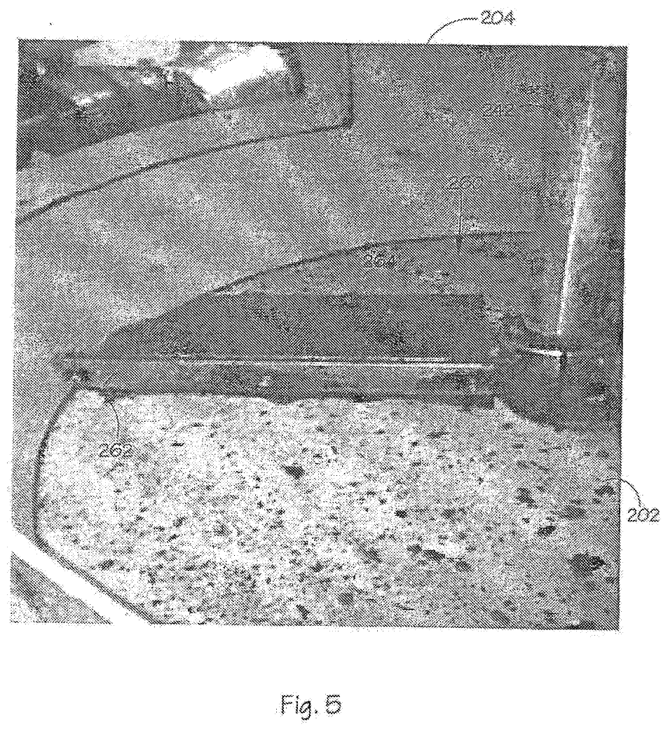

FIG. 5 shows an enlarged three-dimensional view of a portion of the biological reactor of FIG. 4;

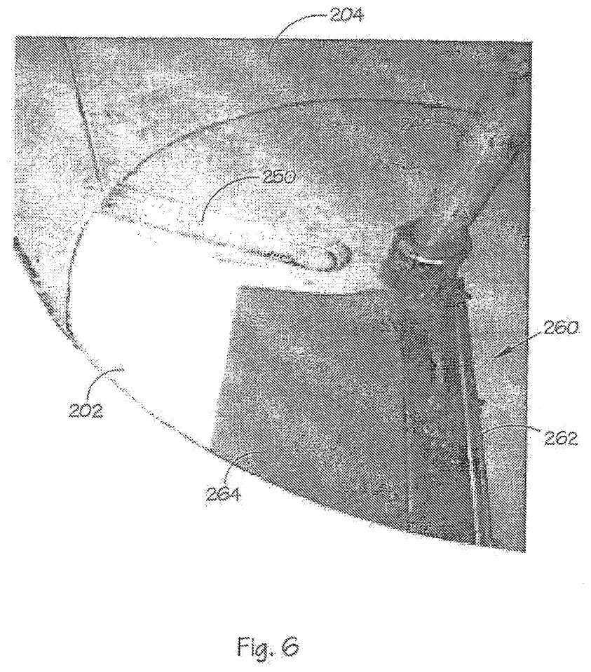

FIG. 6 shows another enlarged view of the biological reactor of FIG. 4; and

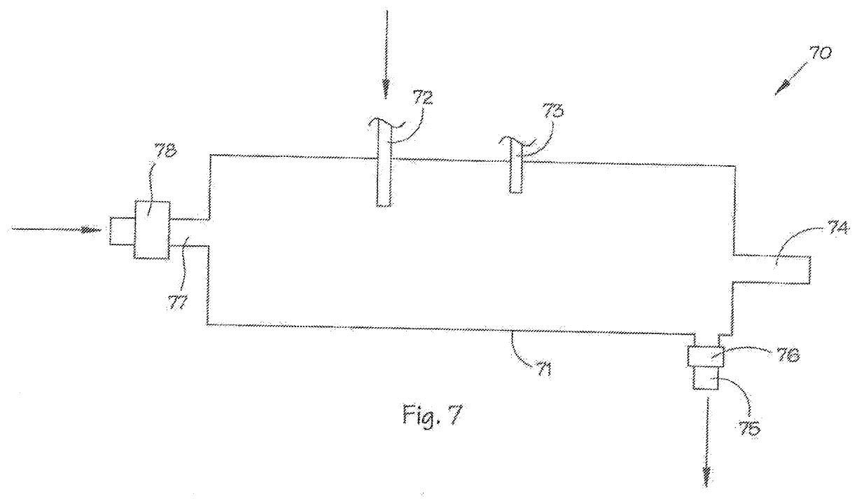

FIG. 7 shows a sketch of part of the control means of the scrubber of FIG. 3.

Referring to FIGS. 1 and 2, reference numeral 10 generally indicates an air purification installation according to the invention.

The installation 10 includes a scrubber generally indicated by reference numeral 12, a biological reactor generally indicated by reference numeral 14 and a cyclone generally indicated by reference numeral 16.

The scrubber 12 has a polluted air inlet, generally indicated by reference numeral 18, with the suction side of an electrically driven fan 20 connected to an outlet conduit 19 of the scrubber. Thus, as the fan rotates, it creates a suction in the scrubber 12, thereby drawing in polluted air through its inlet 18. A discharge cowling 22 of the fan 20 is connected to a lower end portion of the reactor 14 so that, in use, polluted air withdrawn from the scrubber 12 by the fan 20 passes into the lower end portion of the reactor 14.

The reactor 14 has a clean air discharge 24.

A discharge conduit 26 leads from an opening adjacent a floor 28 of the reactor 14 into the body 30 of the cyclone 16. An air discharge 32 of the cyclone 16 is operatively connected to the suction side of the fan 20 by means of a conduit 34. Thus, in use, the fan 20 also provides the required air suction for the cyclone 16 to function. A solids discharge 36 of the cyclone 16 discharge the solids into a bag 38. The solids discharge 36 may be fitted with a small water injector (not shown) for ensuring that the solids are kept moist.

With reference also to FIGS. 3 and 7, the scrubber 12 comprises a tubular body 40 arranged horizontally. At its one end, the body 40 is provided with a tapered component 42 defining the inlet 18. Immediately adjacent the component 42 is provided a primary baffle 44 (in the form of a packed media bed) for removal of air-borne solids from polluted air entering the opening 18. Below the baffle 44 is provided a solids tank 46 into which the removed solids fall for removal from time to time.

The scrubber 12 includes two pall ring packed beds 48 which are spaced apart along the length of the body 40 with an outlet 50, connected to the suction side of the fan 20, being provided at or towards the other end of the body 40. A brine tank 52 is located below the body 40. A brine circulation pump 54 is provided for circulating brine from the tank 52 back into the body 40 through openings 56. It will be appreciated that suitable spray means (not shown) such as a spray bar, will usually be connected to the brine openings 56, to ensure even distribution of brine throughout the scrubber 16.

A drift eliminator 58 is provided in the body 40 downstream of the second packed bed 48, for separating moisture droplets from the air before it exits the scrubber 16.

A conduit 59 connects the brine tank 52 to a sand filter/backwash unit 60. The unit 60 comprises a circulation pump (not shown), a sand filter (not shown) through which brine passes and which removes solids from the brine. The unit 60 is also adapted (not shown) so that the sand filter can be backwashed from time-to-time. By constantly cleaning the sand filter through backwashing, maximum removal of impurities from the scrubber brine is ensured, resulting in, amongst others, optimization of chemical usage, e.g. optimization of ozone production and consumption. The main function of the sand filter is to keep the scrubber brine clean of “scrubber waste” washed out in the air cleaning process in the scrubber 12. This maximizes the continual high efficiency of the scrubber, with reduced or minimal chemical consumption.

In the scrubber 16, solids entrained in air entering the scrubber inlet 18 will be trapped by the baffle 44 and will fall under gravity into the solids tank 46. The air thereafter enters the main treatment zone of the body where it is sprayed with brine that is recirculated through the openings 56 (optionally together with fresh make-up water). The air is thus moistened and is effectively washed so that a number of pollutants, i.e. a cocktail of pollutants, including hydrogen sulphide (H₂S) are washed from the air, with the pollutants being dissolved and/or absorbed into the brine. The scrubbing action is aided by the packed beds 48. In particular, H₂S is thus adsorbed into the scrubber brine.

The scrubber 60 includes, adjacent the baffle 44, a H₂S probe 80.

An ozone generator 100 is also provided. An ozone dosing conduit 102 leads into the pipe 59 leading into the backwash unit 60.

The total dissolved solids (TDS) and conductivity of the scrubber brine is constantly monitored by a control system (not shown). Should either the TDS content or the conductivity level of the scrubber brine reach its set point (set by a high or maximum level of TDS and/or conductivity in the brine), this will dictate that a backwash of the sand filter is required. However, the control system will also include an H₂S controller. The H₂S controller will take a sample of the scrubber brine and analyse it; should any trace of H₂S be found in the brine, the backwash signal will be delayed for a period of time, typically 20 minutes. The ozone production of the unit 110 will be corrected by an ORP (oxidation reduction potential) controller. This information, together with the amount of H₂S detected at the inlet of the filtration system through the probe 80 will permit the controller to take corrective steps, thereby optimizing the use of pH control chemicals and additional load relief of, for example, the biological reactor 14.

The control system also includes a pH controller 110 which is connected to a caustic (NaOH) dosing pump 112 with a dosing conduit 114 leading from the pump 112 into the scrubber body 40. By means of the controller 110, dosing pump 112 and dosing conduit 114, sodium hydroxide (caustic) is injected into the scrubber 12, for controlling and maintaining the pH of the scrubber water/brine.

A conductivity and total dissolved solids (TDS) monitoring device 120 forms part of the control system. The device 120 is provided with a brine sampling line 122.

The control system includes an H₂S oxidation test unit, generally indicated by reference numeral 70 (see FIG. 7). The unit 70 includes a two litre container 71, an acid injector 72 leading into the vessel 71 from an acid container 84, an H₂S detector 73 also leading into the vessel 71, an overflow conduit 74 leading into the container 71, a drainage conduit 75 fitted with an electro valve 76 for draining spent brine after testing thereof in the vessel 71, and a brine sample inlet conduit 77, fitted with an electro valve 78, leading into the container 70 from the unit 60.

The control system is also connected to the H₂S probe 80.

When a signal that the predetermined set (maximum) level for either TDS or conductivity in the brine has been reached, is read by a PLC (Programmable Logic Controller) forming part of the control system, a scrubber brine sample of two litres is drawn into the container 71 through the conduit 77. A few millilitres of acid, such a vinegar, is injected into the container 71 through the injector 72, for pH control, i.e. to obtain a neutral pH of 7. If the presence, of H₂S in the brine is detected by the detector 73, the control system will block the backwash cycle of the sand filter while ozone production by the ozone generator 110 will be increased; the test will be repeated every 30 minutes until all H₂S in the brine has been oxidized so that the brine is then safe for dumping.

The PLC is used to monitor the inflow of H₂S entering the scrubber 15 (probe 80), the effect on the pH of the brine and the dosage of caustic required to oxidize the H₂S absorbed in the scrubber brine, to ensure that all H₂S is oxidized, and to prevent backwashing of the sand filter if there is H₂S present in the brine.

It will be appreciated that if the control system determines that there is no H₂S present in the brine when a backwash is demanded based on TDS levels and/or conductivity level, the backwash cycle will continue.

More specifically, the moment backwash of the sand filter is dictated by a high TDS or conductivity level sensing, the backwash request will go on hold and an H₂S as hereinbefore described will be done by the control system. Thus, a sample of the scrubber brine will be delivered into the unit 70 by means of the valve 78 whereafter a small dosage of vinegar will be injected until the pH of the brine in the unit 70 is 7. If the H₂S detector 73 detects no H₂S in the brine sample, the backwash will continue. The PLC has a first H₂S reference value, namely the H₂S influx, i.e. the H₂S in the air, as mentioned by the probe 80. If, in the H₂S, no H₂S is detected, this could mean that the caustic level in the brine may be too high; the controller then reduces the pH by one point by controlling the level of caustic (sodium hydroxide) injection. In this fashion, the PLC is optimized by using information at hand to optimize he pH and the ozone use.

At start-up of the installation 10, the detecting means are set on a given value in respect of conductivity level, TDS level and back pressure, with these values being processed through a PID loop.

Through the information contained in the PID loop, the controller will know when a rise in H₂S levels can be expected and commence dosing NaOH; depending on the levels being run, another ozone generator can be started up in order to stockpile ozone for a rise in H₂S based on historic values; likewise, when the H₂S reduce, the controller will reduce O₃ production and adjust pH appropriately, e.g. by increasing caustic dosage.

However, should the PLC detect H₂S in the H₂S detection after a backwash request, it will immediately update the pH and O₃ values.

The PLC controlling the backwash unit monitors three sets of inputs on which a backwash decision must be made:
1. Back pressure in the sand filter caused by fine solids collected from the primary packed bed; these fine solids drop directly into the small compartment 46 in the brine tank 52 thus preventing it from diluting into the main tank; from here they pass through the sand filter and into the main tank.
2. Conductivity—if the conductivity is too high, the NaOH injection will increase with this correction being effected by the PID loop.
3. TDS—if the TDS level is too high, the NaOH use will increase, with correction being effected by the PID loop.

Thus, in a nutshell, sodium hydroxide is injected into the brine to raise and to maintain its pH at an optimal level for the complete adsorption therein of all the hydrogen sulphide in the airstream; to achieve this the scrubber brine must be as clean as possible in order to maintain the pH, with the minimum of sodium hydroxide; the cleaning of the brine is determined by the conductivity and the total dissolved solids levels in the brine, while ozone is injected into the brine to oxidize the hydrogen sulphide to a sulphate. This entire process is controlled and optimized by a PLC taking the H₂S value at the inlet airstream to the scrubber and comparing it with the pH. If a pH reduction is measured, it will then increase the dosing to maintain the pH, and then test the brine for H₂S. With this result, the PLC can optimize the chemical use as well as the ozone production and assure that the brine is H₂S free. The conductivity and dissolved solids levels of the brine is controlled by a separate program on given set points but regulated by the PLC to ensure no H₂S is present when any set points are reached. Should there be H₂S in the brine the PLC will raise the ozone production until the system is optimized on all the levels.

The scrubber 12 is thus a three-stage horizontal scrubber with poll ring packing, and having an air flow of 1 m/sec. It is equipped with an inlet air (H₂S) sensor 80 as well as an outlet air (H₂S) sensor (not shown) by means of which the concentration of H₂S in the air can be determined and hence the overall efficiency of the scrubber calculated. This is done by the control system.

The main function of the PLC is to optimize the functions of every phase and process with the minimum of water, energy and chemicals. The uniqueness of the invention is the huge cost saving and safety factor that it offers by controlling the different functions of the system that are extremely reliant on each other to make the system so effective.

The process commences by the inlet gas reading (probe 80). This reading is stored as benchmark reference determined by the quality and age of the incoming effluent at that moment. The PLC will then read the outlet air value. This will give the efficiency of the scrubber. Simultaneously, the control system records the pH. TDS and conductivity, if the demand for a back wash is received from TDS or conductivity and the result is negative the back wash will commence and the PLC through the PID loop can start decreasing the pH using very fine adjustments keeping the H₂S inlet as a reference to optimise the pH for that H₂S load; after a few cycles the PLC will be able to increase the pH purely on an increase of the H₂S inlet gas value, preparing the scrubber brine for the increase of H₂S load, now the scrubber can do the same with the ozone generator, to correlate the ozone production with the H₂S gas inlet. This will be done together with the ORP controller of the ozone unit.

With reference also to FIGS. 4, 5 and 6, the reactor 14 includes an upright cylindrical vessel, generally indicated by reference numeral 200. The vessel 200 includes a flat circular base or base plate 202 to which is mounted a first circular cylindrical wall component 204. The upper end of the wall component 204 is closed off with a foraminous or perforated plate 206. An air inlet chamber is thus defined between the base 202, the plate 206 and the wall section 204, with the plate 206 constituting a roof of the air inlet chamber 208. A solids collection zone 210 is also defined immediately above the floor 202, as hereinafter described. An air inlet opening 212 is provided in the wall section 204 adjacent the roof 206, with a flared connection 214 provided around the air inlet opening 212, for connection to the cowling 22 of the fan 20.

A cylindrical wall component 216 is mounted on the plate 206, with a perforated plate 218 dosing off the upper end of the wall component 215. An air conditioning chamber, generally indicated by reference numeral 220, is defined between the plate 206, which thus constitutes the floor of the chamber 220, the wall component 216 and the plate 218, which thus constitutes a roof of the chamber 220. The chamber 38 includes a bed of micro-organism-containing primary separating media, with a water spray arrangement 224 located immediately below the plate 218 for spraying water onto the bed 222. In use, air entering the chamber 208 passes upwardly through the chamber 220 and fluidizes the bed 222 while the bed is kept continuously moist. The micro-organism-containing primary media of the bed 22 serve to remove or decompose organic pollutants present in the polluted air that enters the reactor 14.

The primary separating media may be 3-5 mm diameter plastic beads coated with an organic biofilm on which, in use, microbes settle and digest odorous molecules present in the air passing through the bed 222. The resultant product or excrete is deposited on the beads; when this layer becomes too thick it becomes unstable and abrades, thereby dropping off and passing through the openings (typically 3 mm openings) in the plate 206 and then onto the floor 28.

A cylindrical wall component 225 is mounted to the plate 218 so that the plate 218 constitutes a floor therefor. A bed 226 of secondary media, e.g. hardened zeolite granules or high grade (e.g. coconut shell) actuated carbon particles, is provided on top of the floor 218. In use, the bed 226 is a static bed and serves to polish polluted air emerging from the fluidized bed 222. An air purification chamber, generally indicated by reference numeral 228, is thus defined between the floor 218, the wall 224 and a cover plate or roof 228 closing off the top of the vessel 200. A clean air outlet 230 is provided in the roof 228.

The water sprayed onto the fluidized bed 222 through the sprayers 224 will ensure that the static bed 226 is also kept moist, thereby to optimize bacterial growth but block the absorption effect of the particles, particularly when the particles are carbon particles. This static bed filtration will, it is believed, enhance the efficiency of removal of complex aromatic combinations of hydrocarbons in the air.

The purpose of the static bed 226 is to remove and polish remains of complex aromatic components that just need the extra second contact time to be completely digested, it also serves as a slight back pressure to the main fluidized bed's stability.

Lifespan of the media in this bed is years due to the fact that its function is not dependable on the filtration capabilities of the base material but on it's ideal surface structure to house the microbes.

The reactor 14 also includes a mixer, generally indicated by reference numeral 240. The mixer 240 comprises an axially located rotatable shaft 242 extending the full length of the vessel 200 and connected, at its upper end, to an electric motor/gearbox combination 244 which drives the shaft 242 to rotate. The lower end of the shaft 242 is mounted in a thrust bearing 244 mounted to the floor 202. A plurality of mixing paddles 246 protrude radially outwardly from the shaft 242 within the bed 222 so that, in use, the paddles 246 serve to agitate the fluidized bed 222. The paddles 246 are spaced angularly apart as well as longitudinally apart along the shaft 242.

A radially extending channel 250 is provided in the floor 202, with the pipe 26 connect to the open outer end of the channel 250. A sweeper, generally indicted by reference numeral 260, is mounted to the lower end portion of the shaft 242. The sweeper 260 comprises an arm 262 to which is mounted a trailing flexible sweeper or squeegee component 264, e.g. a piece of flexible relatively soft rubber or the like. In use, pollutants that are removed from polluted air as it passes through the fluidized bed 22, and which form solid reaction products through reaction of micro-organisms with the pollutants, accumulate on the primary media. Through the continual action of the primary media on each other as a result of the fluidization and mixing of the bed, the solid material is continually removed/abraded from the primary media and falls through the foraminous plate 206 to be collected in the zone 210, i.e. it accumulates on the floor 202. The sweeper 260 sweeps the solid material into the channel 250 from where it is withdrawn, through suction generated in the cyclone 16 by the main fan 20, along the pipe 26 into the cyclone. The component 264, apart from sweeping the solids into the channel 250, also seals off the top of the filled channel (aided by the positive air pressure in the reactor pressing down on the component 264), thereby enhancing suction along the pipe 26. In the cyclone 14, the solid material is separated from the air which is returned to the suction side of the fan 20 by the conduit 34. The solid material exits the cyclone 16 through the outlet 36 and is discharged into bags 38 for disposal or use thereof.

Humidity in the fluidized bed 222 is controlled by a simple but accurate method: the conductivity is measured across the bed 222 using a cathode (not shown) which is one-third of the circumference of the reactor 14, and an anode (not shown) which one-third of the cathode, with the current across the bed being measured.

The control system also automatically regulates the start-up of the installation or plant 10 as follows:
1. Start-up procedure (program the control system to start up the plant 10 and run for 10 minutes at least once a week during operational shut down or remove the media of the body in the reactor and store in sealed bags.) Do all safety checks. If the plant 10 fails to start follow the steps:
   (a) Check humidity reading in the reactor 14; if more than 20% below set point refuse start-up and follow check list: Open top door of reactor, check humidity of media in the beds 222, 226, if OK check power leads to electrodes, check contacts on electrodes for corrosion or decay, replace or repair.
   (b) If plant has been off for a few days dig in the media and check humidity deep down, if reading still show low, water physically.
2. Fan 20 and scrubber pump 52 start automatically
3. Mixer 240 starts after 15 seconds.
4. After 20 minutes H₂S tester will demand a test back wash cycle; if no H₂S is detected, plant 10 will start.
5. Plant 101 is now calibrated for normal operation.

Thus, the installation 10 provides a multiple phase air treatment system commencing with solids removal in the baffle 44 of the scrubber 12, soluble pollutant removal (including H₂S and NH₃ removal) through water scrubbing in the scrubber 12, biological removal of high pH contaminants in the fluidized bed 222 and removal of remainder of aromatic pollutants in the static bed 226.

The installation 10 accordingly provides, amongst others, the following features and advantages associated therewith:
a scrubber with H₂S detection and constant brine cleaning, to optimize oxidation processes;
the cleaning of the scrubber brine is effected in a filtration/backwash unit so that the contaminants are concentrated so that small quantities of water only need to be disposed of and chemical use is optimized;
early detection of H₂S in the brine is possible and can be corrected. For example, it is believed that caustic usage will be in the range of 2-3 kg/day.
allows calibration and adjustment of H₂S removal to 100% efficiency and safety;
biofilter collection and bagging of bio waste;
static bio bed after a fluidized bio bed.

The installation 10 also provides another important advantage in that ozone is required only for H₂S oxidation, not for oxidation of other pollutants.

This concept of an integrated air purification plant or system specifically targeted at the removal of high concentrations of a cocktail of odorous components from Sulphurs to organic and inorganic in the same airstream, the system commences with scrubbing then adsorption and oxidation then with in situ bread microbes to address the next group and finally the polishing in the static bio bed before the clean air is released in the atmosphere.

1-37. (canceled)

38. A process for purifying polluted air, which process includes
passing polluted air through a fluidized bed of micro-organism-containing primary particulate media so that, as the polluted air passes through the fluidized bed, organic pollutants therein are removed by the micro-organisms, with partially purified air containing a lower level of the organic pollutants than the polluted air that enters the fluidized bed, emerging from the fluidized bed; and
passing the partially purified air through a static bed of secondary particulate media thereby to remove residual organic pollutants from the partially purified air, with purified air being produced.

39. The process according to claim 38, wherein the static bed is located above the fluidized bed so that the partially purified air passes upwardly from the fluidized bed through the static bed, with the purified air being withdrawn from the top of the static bed and wherein the secondary particulate media are particles of activated carbon or zeolite.

40. The process according to claim 38, further including controlling the humidity of the fluidized bed and/or simultaneously stirring the fluidized bed as the polluted air passes through it, to enhance removal and/or decomposition of the microorganisms.

41. The process according to claim 38, which includes
allowing solid matter that accumulates on the particulate media as pollutants are removed from the polluted air as it passes through the fluidized bed, to segregate therefrom and to pass into a collection zone below the fluidized bed; and
removing the solid matter from the collection zone.

42. The process according to claim 41, wherein the collection zone includes a floor on which the solid matter accumulates, and an opening through which the solid matter is removed, the removal of the solid matter being by means of suction, with the suction being created by a cyclone operatively connected to the opening.

43. The process according to claim 42, wherein the collection zone is circular in cross section, with a radially extending channel being provided in the floor of the collection zone, and with the outer end of the channel providing said opening and being connected to the cyclone, the process further including urging solid matter that accumulates on the floor into the channel by means of a rotating sweeper which sweeps solid matter on the floor into the channel as it rotates, such that, as the sweeper rotates, the sweeper momentarily seals off the channel thus creating a vacuum in the channel filled with solid matter which is extracted Over the entire radius of the floor into the cyclone.

44. The process according to claim 38, which includes initially, before passing the polluted air through the fluidized bed,
passing it through a scrubbing zone in which the air is scrubbed with brine, thereby removing pollutants, including hydrogen sulphide, from the air, and with the pollutants being entrained by and/or adsorbed by and/or dissolved in the brine;
controlling the pH of the brine to enhance hydrogen sulphide adsorption;
cleaning the brine to remove entrained, adsorbed and/or dissolved pollutants therefrom;
treating the brine to convert hydrogen sulphide therein to a salt; and recycling the treated brine to the scrubbing zone.

45. The process according to claim 38, which includes initially, before passing the polluted air through the fluidized bed,
passing it through a scrubbing zone in which the air is scrubbed with brine, thereby to pretreat the polluted air, and with pollutants, including hydrogen sulphide, being entrained by and/or adsorbed by and/or dissolved in the brine; and
thereafter, passing the pretreated polluted air through a bed of micro-organism-containing particulate media so that, as the polluted air passes through the bed, organic pollutants therein are removed by the micro-organisms, with purified air containing a lower level of the organic pollutants than the polluted air that enters the bed, emerging from the bed.

46. The process according to claim 45, further including
controlling the brine pH to enhance hydrogen sulphide absorption; and/or
cleaning the brine to remove entrained, adsorbed and/or dissolved pollutants therefrom; and/or
treating the brine to convert H₂S therein to a salt; and/or
recycling the brine to the scrubbing zone.

47. An air purification apparatus, which includes
a vessel providing an air purification chamber, with the vessel being adapted such that polluted air can enter the air purification chamber at a low level;
a plurality of micro-organism-containing primary particulate media in the air purification chamber, the primary particulate media being capable of being fluidized by air which passes through the air purification chamber; and
a bed of secondary particulate media located above the primary particulate media so that, in use, partially purified air emerging from the fluidized bed passes through the bed of secondary particulate media, for further purification thereof.

48. The apparatus according to claim 47, which further includes water injection means adapted to spray water onto the micro-organism-containing primary particulate media, or into a zone above said media and below the bed of secondary particulate media and/or which further includes a mixer in the air purification chamber for mixing a fluidized bed or the primary particulate media which forms in the air purification chamber, in use.

49. The apparatus according to claim 47, which includes an air purification zone within the chamber and adapted to contain a bed of primary particulate media comprising micro-organism-containing particulate media; and a solids collection zone below the air purification zone, with a solids removal opening in the vessel for removing solids from the solids collection zone, the vessel including, in the air purification zone, a foraminous support supporting, the bed and which permits solids to pass from the bed into the collection zone and a floor for the collection zone, the floor of the vessel being of circular cylindrical form so that collection zone is circular in cross-section, wherein a radially extending channel is provided in the floor of the collection zone, and wherein a rotating sweeper, which sweeps solid matter on the floor into the channel as it rotates, is provided such that, in use, the sweeper momentarily seals off the channel thus creating a vacuum in the channel filled with solid matter.

50. An air scrubber, which includes
a vessel defining a scrubbing zone and having an air inlet and air outlet;
brine introduction means for introducing scrubbing brine into the scrubbing zone;
air contact media within the scrubbing zone;
brine recycling means for recycling brine to the brine introduction means;
pH control means for controlling the pH of the brine;
brine cleaning means for cleaning the brine; and
hydrogen sulphide treatment means for treating hydrogen sulphide present in brine.

51. The air scrubber according to claim 50, wherein the brine cleaning means includes a filter, for filtering spent brine, connected to the vessel, the filter being connected to the vessel by means of a brine conduit, and wherein the hydrogen sulphide (H2S) treatment means comprises oxidation means for oxidizing the H₂S.

52. The air scrubber according to claim 51, wherein the oxidation means comprises an ozone generator and an ozone conduit leading into the brine conduit, such that ozone is injected or introduced into the brine conduit by means of a venture mounted in the brine conduit and connected to the ozone conduit.

53. An air purification installation, which includes
an air scrubber having an air inlet and an air outlet spaced from the inlet;
a vessel providing an air purification chamber, with an air purification zone, adapted to contain a bed of micro-organism-containing media, being provided within the chamber; and
air displacement means between the scrubber and the vessel, with the scrubber air outlet being connected to an air inlet of the air displacement means, and an air outlet of the air displacement means being connected to the vessel.

54. The air purification installation according to claim 53, wherein the air scrubber comprises:
a vessel defining a scrubbing zone and having an air inlet and air outlet;
brine introduction means for introducing scrubbing brine into the scrubbing zone;
air contact media within the scrubbing zone;
brine recycling means for recycling brine to the brine introduction means;
pH control means for controlling the pH of the brine;
brine cleaning means for cleaning the brine; and
hydrogen sulphide treatment means for treating hydrogen sulphide present in brine.

55. The air purification installation according to claim 53, wherein the vessel comprises:
an air purification chamber, with the vessel being adapted such that polluted air can enter the air purification chamber at a low level;
a plurality of micro-organism-containing primary particulate media in the air purification chamber, the primary particulate media being capable of being fluidized by air which passes through the air purification chamber; and
a bed of secondary particulate media located above the primary particulate media so that, in use, partially purified air emerging from the fluidized bed passes through the bed of secondary particulate media, for further purification thereof.
